(19) United States
(12) Patent Application Publication
(10) Pub. No.: US 2012/0158772 A1
(43) Pub. Date: Jun. 21, 2012

(54) AUTOMATED GENERATION OF STRUCTURED SERVICE DESCRIPTIONS FROM SEMI-STRUCTURED ENTERPRISE SERVICE REPOSITORIES

(75) Inventors: Victor Shafran, Kfar Edumim (IL); Eliezer Levy, Haifa (IL); Michael Stollberg, Dresden (DE)

(73) Assignee: SAP AG, Walldorf (DE)

(21) Appl. No.: 12/972,756

(22) Filed: Dec. 20, 2010

(51) Int. Cl. G06F 17/30

(52) U.S. Cl. 707/769; 707/803; 707/E17.014; 707/E17.044

(57) ABSTRACT

Implementations of the present disclosure include methods for generating structured service descriptions corresponding to one or more enterprise services. In some implementations, methods include defining a unified schema based on a governance process that is used to develop enterprise services stored within a business service repository, executing a first data importer and a second data importer, retrieving first data and second data from the business service repository using the first data importer and the second data importer, respectively, the first data and the second data corresponding to the enterprise services, automatically generating structured service descriptions based on the first data and the second data, each of the structured service descriptions corresponding to the unified schema and being associated with one of the enterprise services, and storing the structured service descriptions in a service repository, the service repository being provided in a computer-readable storage medium.

### BACKGROUND

Service oriented architecture (SOA) is a system design methodology, in which enterprise services are used as a standard way to expose business functionality from enterprise systems. This makes the business functionality accessible and reusable in a variety of applications and processes deployed in organizations. Enterprise services provide programmatic access to an immense, and already existing, pool of business data and functionality provided by large enterprise applications. Example enterprise applications include Enterprise Resource Planning (ERP) and Customer Relationship Management (CRM) applications provided by SAP AG of Waldorf, Germany. The reuse of enterprise services enables rapid, agile and cost-effective development of composite applications. Enterprise services can represent highly-integrated web services that access defined business data and logic of existing business processes. An aim of enterprise services is to enable cost efficient development of custom business solutions which introduce a set of requirements for an enterprise service infrastructure. These requirements include service provisioning, management and especially an efficient means for service consumption.

Existing technical infrastructures for enterprise service repositories are designed for highly trained human professionals with deep domain knowledge in the specific business area. This makes enterprise service search, discovery and consumption costly tasks for the following reasons: the enterprise services are not accessible for automatic tools that allow efficient service discovery and composition (e.g., mash-up engines), and software developers that build custom business solutions may lack the knowledge required to identify relevant enterprise services. As a result, the task of service consumption requires collaboration between the software developer and the business expert. This, in turn, increases the cost of the task.

### SUMMARY

Implementations of the present disclosure include computer-implemented methods for generating structured service descriptions corresponding to one or more enterprise services. In some implementations, methods include defining a unified schema based on a governance process that is used to develop enterprise services stored within a business service repository, executing a first data importer and a second data importer, retrieving first data and second data from the business service repository using the first data importer and the second data importer, respectively, the first data and the second data corresponding to the enterprise services, automatically generating structured service descriptions based on the first data and the second data, each of the structured service descriptions corresponding to the unified schema and being associated with one of the enterprise services, and storing the structured service descriptions in a service repository, the service repository being provided in a computer-readable storage medium.

In some implementations, the first data importer includes a resource description framework (RDF) importer, the unified schema including an RDF schema, and the first data includes structured programmatic access information for accessing the enterprise services. In some implementations, generating structured service descriptions includes transforming the first data to one or more RDF tuples. In some implementations, each of the one or more RDF tuples comprises an RDF triple having a subject, predicate and object.

In some implementations, the second data importer includes a meta-data importer and the second data includes semi-structured information regarding the enterprise services. In some implementations, generating structured service descriptions includes transforming the second data to one or more corresponding RDF tuples. In some implementations, each of the one or more RDF tuples comprises an RDF triple having a subject, predicate and object.

In some implementations, the first data includes technical interface data corresponding to the enterprise services and is provided in a format for describing enterprise services. In some implementations, the format corresponds to Web Service Description Language (WSDL).

In some implementations, the second data includes one or more of business context data, business process data and system version data, and the second data is provided in a semi-structured format. In some implementations, the format corresponds to Hyper-text Mark-up Language (HTML).

In some implementations, methods further include: executing, using one or more processors, a third data importer, and retrieving third data from a data repository using the third data importer, the data repository being provided in a computer-readable storage medium and the third data corresponding to the enterprise services, wherein the structured service descriptions are generated further based on the third data. In some implementations, the third data corresponds to one or more application program interfaces (APIs) associated with the enterprise services.

In some implementations, methods further include: receiving user input, querying the service repository based on the user input, generating results based on querying, and outputting the results to a user. In some implementations, the user input is provided in SPARQL Protocol and RDF Query Language (SPARQL). In some implementations, the user input is generated by one of a human user and a programmatic user.

In some implementations, methods further include: receiving user input, and configuring the second data importer to recognize a set of elements of the second data and to map the second data to a schema associated with the service repository. In some implementations, the set of elements comprises HTML elements that hold the second data, the second data importer being configured to map the second data to RDF predicates.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example system architecture that can perform implementations of the present disclosure.

FIG. 2 is a block diagram depicting an example framework for generating service descriptions from an enterprise service repository.

FIG. 3 depicts an example process for generating service descriptions from an enterprise service repository.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are generally directed to generating richer, structured service descriptions for enterprise services from a business service repository. Implementations of the present disclosure provide an automatic extraction framework for extracting and combining both the technical and usage data of enterprise services into a single repository that is accessible for both humans and application programs. The data repository provides rich and structured service descriptions that are useful for enterprise service discovery and composition.

An enterprise service is a callable entity that provides business functionality and is published in a business service repository. An example business service repository includes the enterprise services repository (ESR) provided by SAP AG of Walldorf, Germany. Enterprise services are structured according to a harmonized enterprise model based on global data types (GDTs), process components, and business objects. In some implementations, enterprise services are well documented, safeguard quality and stability and are based on open standards. A governance process underlines the definition and construction of particular enterprise services. An example governance process includes the process integration content (PIC) methodology provided by SAP AG. Governance processes provide mandatory modeling and implementation guidelines for each new enterprise service development, a special review process having a plurality of quality gates, and regularly executed manual and automated tests for each service operation to safeguard functional correctness. When a governance process employed in enterprise service development, the naming conventions for enterprise services and parameters are homogeneous across various enterprise services. Moreover, unified and consistent business vocabulary is used across all of the so-developed enterprise services. In this manner, and as discussed in further detail herein, the governance process used for developing the particular enterprise services of the business service repository provides the basis for defining richer description structures within a chosen schema as the heart of a resultant schema repository.

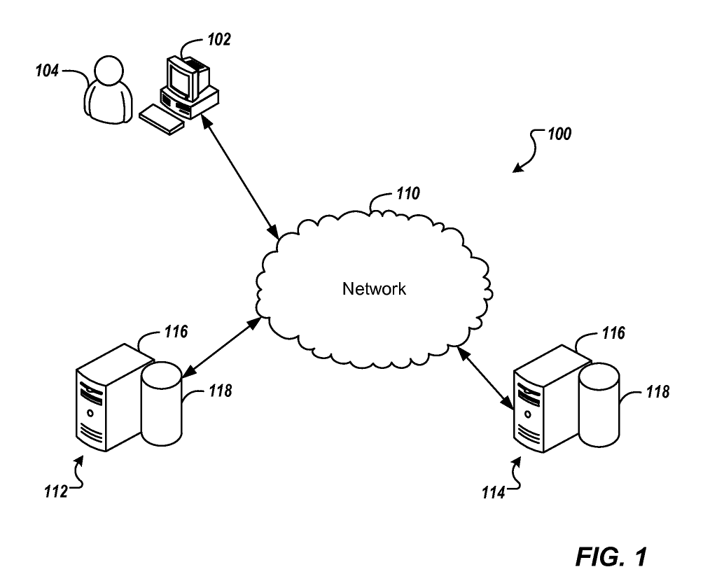

Referring now to FIG. 1, a block diagram depicts an example architecture 100 that can be used in accordance with implementations of the present disclosure. The example architecture 100 includes a computing device 102 associated with a user 104, a network 110, a computing system 112 and a computing system 114. The computing device 102, the computing system 112 and the computing system 114 can communicate with each other through the network 110. The computing systems 112, 114 can include a computing device 116 (e.g., a server) and one or more computer-readable storage devices 118 (e.g., a database).

Each computing device 102, 116 can represent various forms of processing devices including, but not limited to, a desktop computer, a laptop computer, a handheld computer, a personal digital assistant (PDA), a cellular telephone, a network appliance, a camera, a smart phone, an enhanced general packet radio service (EGPRS) mobile phone, a media player, a navigation device, an email device, a game console, or a combination of any two or more of these data processing devices or other data processing devices. The computing devices 102, 116 may be provided access to and/or receive application software executed and/or stored on any of the other computing systems 102, 116. The computing device 116 can represent various forms of servers including, but not limited to a web server, an application server, a proxy server, a network server, or a server farm. For example, the computing devices 126 can be an application server that executes software provided by software vendor entity 102.

In some implementations, the computing devices may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some implementations, the architecture 100 can be a distributed client/server system that spans one or more networks such as network 110. The network 110 can be a large computer network, such as a local area network (LAN), wide area network (WAN), the Internet, a cellular network, or a combination thereof connecting any number of mobile clients, fixed clients, and servers. In some implementations, each client (e.g., computing device 102) can communicate with servers (e.g., computing devices 116) via a virtual private network (VPN), Secure Shell (SSH) tunnel, or other secure network connection. In some implementations, the networks 110 may include a corporate network (e.g., intranet) and one or more wireless access points.

Implementations of the present disclosure provide a generic approach that enables the extraction of the semi-structured information and meta-data corresponding to one or more enterprise services stored within a business service repository in a structured manner. For example, a business service repository can be maintained by the computing system 112 of FIG. 1. Implementations of the present disclosure combine the semi-structured information and meta-data with the technical access information and store the result in a service repository. For example, a service repository can be created and maintained by the computing system 112 and/or the computing system 114 of FIG. 1. Extraction is performed in an automatic manner and can include a manual configuration phase. The resultant structured information is stored in the service repository, which enables automatic information querying. In some implementations, the structured repository is provided as a resource description framework (RDF) repository, and querying is achievable without knowing the RDF schema in advance. Accordingly, a structured description of enterprise services can be defined using a standardized schema to automatically produce meaningful and automatically processable service descriptions.

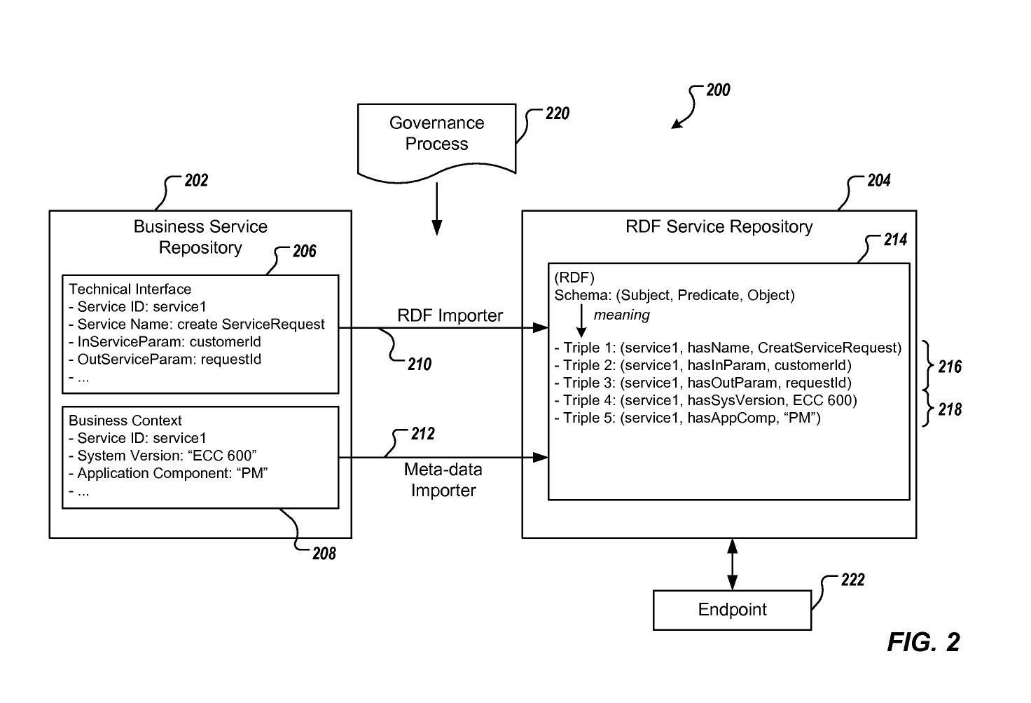

Referring now to FIG. 2, an example framework 200 in accordance with implementations of the present disclosure will be discussed. The example framework 200 includes a business service repository 202 (e.g., provided in a computer-readable storage medium) and an RDF service repository 204 (e.g., provided in a computer-readable storage medium). The business service repository 202 can electronically store data regarding one or more enterprise services. In the example of FIG. 2, the data includes technical interface data 206 and business context data 208. Importers are also provided, and include an RDF importer 210 and a meta-data importer 212. In some implementations, the importers 210, 212 include one or more programs that are executed by one or more computing devices (e.g., computing devices 116 of FIG. 1). In some implementations, additional data sources regarding the enterprise services can be accessed. Example data source can include an application program interface (API)-oriented source, and/or one or more databases. API-oriented indicates that programs, or computational facilities, are provided via APIs, and may not be offered as technical services. In general, however, it is appreciated that implementations of the present disclosure are not limited to technical services, but can also include data provided in other technical formats that can be used to generate richer and more structured information. In this manner, not only can information provided from the business service repository be used for creating the RDF service repository 204, other information on enterprise services and/or functionalities offered in a different technical form can also be accessed. Additional importers corresponding to the additional data sources can be provided for importing and transforming the data for storage in the RDF service repository 204.

In the example of FIG. 2, the technical interface data 206 includes data associated with an example enterprise service, and can be provided using a format for describing enterprise services (e.g., Web Service Description Language (WSDL)). The example technical interface data 206 includes service identification (Service ID) data having the value “service1” and service name (Service Name) data having a value “create ServiceRequest.” The example technical interface data 206 further includes input parameter (InServiceParam) data having the value “customerId” and output parameter (OutServiceParam) data having the value “requestId.” Although not illustrated in FIG. 2, the technical interface data 206 can include additional data corresponding to the example enterprise service and/or other enterprise services.

In example of FIG. 2, the business context data 208 provides information corresponding to a context of an associated enterprise service, and can be provided using a format (e.g., Hyper-text Mark-up Language (HTML)). The example business context data 208 of FIG. 2 includes service identification (Service ID) data having the value “service1,” system version (System Version) data having the value “ECC 600,” and application component (Application Component) data having the value “PM.” Although not illustrated in FIG. 2, the business context data 208 can include additional data corresponding to the example enterprise service and/or other enterprise services.

The importers 210, 212 transform the data (e.g., technical interface data 206 and business context data 208) stored in the business service repository 202 into structured data 214 stored in the RDF service repository 204. In the instant example, the structured data 214 is in accordance with an RDF schema including one or more RDF triples, each triple including a subject, predicate and object. The RDF importer 210 retrieves low-level, structured programmatic access information, for accessing an enterprise service of the business service repository 202, and transforms the programmatic access information to one or more corresponding RDF triples. For example, the example technical interface data 206 is transformed to a set of RDF triples 216 (Triple 1, Triple 2, Triple 3). Each low-level service description format (e.g., WSDL) includes a format-specific importer. However, once converted, all of the data is stored in the unified schema (e.g., RDF schema).

The meta-data importer 212 retrieves semi-structured information available about the enterprise services and transforms the semi-structured information to one or more corresponding RDF triples. Examples of such data include business context, business process(es) the service belongs to and/or specific system versions that implement the service. In the example of FIG. 2, the business context data 208 is transformed to a set of RDF triples 218 (Triple 4, Triple 5). The meta-data importer 212 can be provided as a generic importer that can be configured before automatic extraction of the business context data. For example, and using HTML as an example format, the meta-data importer can be configured to recognize a specific set of HTML elements that hold the meta-data and that maps the meta-data to RDF triples. By way of non-limiting example, configuration of the meta-data importer 212 can be achieved using the XML path language (XPath). Again, once converted, all of the data is stored in the unified schema (e.g., RDF schema).

Using the RDF importer 210 and the meta-data importer 212, a rich and structured RDF store (i.e., structured data 214) is provided for enterprise service information. The importers 210, 212 are implemented in view of a governance process 220 that is used to develop the subject enterprise services. In this manner, a harmonized and consistent RDF store (i.e., RDF service repository 204) can be created. If changes are made to the business service repository 202, the importers 210, 212 are again executed to keep the RDF service repository 204 up to date.

In accordance with the present disclosure, knowledge of the governance process 220 is leveraged to define an appropriate RDF schema for generating the enterprise service descriptions in the richer and more structured format. In the example of FIG. 2, the enterprise services stored within the business service repository 202 are developed using the same governance process (i.e., the governance process 220). Use of the governance process ensures that all existing enterprise service artifacts (i.e., the enterprise services stored in the business service repository 202) follow the rules and conventions defined in the governance process. The conventions are explicitly represented in the RDF schema through the automatic generation of the RDF triples 216, 218, which form the richer and more structured service descriptions.

With continued reference to FIG. 2, an endpoint 222 can include a computing device that is used to access data stored within the RDF service repository 204. In some implementations, a human user of the computing device and/or an application executed on the computing device can query the RDF service repository 204 to search for and discover enterprise services. In some implementations, a query language can be used to query the RDF service repository 204. An example query language can include the SPARQL query language. The query language can be used to perform structural and declarative queries on the RDF service repository 204 by both humans and programs.

Using the query language at the endpoint 222, humans and/or programs can explore the structure of the business service repository 202, while systematically combining both low-level (i.e., technical) and business terminology. For example, composition of enterprise service can be performed by matching the input and output parameters of different enterprise services with the same data type or name. Further, automatic clustering and tagging can be provided by using the query language to query for all enterprise services that belong to a specific system version or application component. In some implementations, the exact type of extracted meta-data can depend on the type of discovery and composition that may be required. For example, extracting data types of arguments is required to enhance the automatic capabilities of connecting an output argument of one enterprise service to an input argument of another enterprise service, thereby composing the two. The extraction process requires no business expertise. At the same time, the extraction provides systematic access means to the complex business-oriented information enterprise services embody. This systematic access suffices for discovering and composing enterprise services to create a desired application.

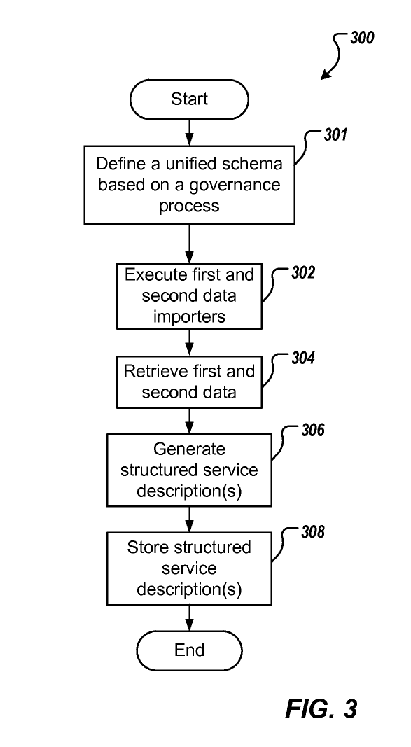

FIG. 3 is a flow diagram of an example process 300 for generating structured service descriptions corresponding to one or more enterprise services. A unified schema is defined based on a governance process that is used to develop enterprise services stored within a business service repository (301). For example, the unified schema can be defined based on user input and the unified schema can include an RDF schema. A first data importer and a second data importer are executed using one or more processors (302). For example, each of the first data importer (e.g., RDF importer 210 of FIG. 2) and the second data importer (e.g., meta-data importer 212 of FIG. 2) can be provided as an executable program that is executed using one or more processors (e.g., computing device 116 of FIG. 1). First data and second data are retrieved from the business service repository (e.g., business service repository 202 of FIG. 2) using the first data importer and the second data importer, respectively (304). The business service repository can be provided in a computer-readable storage medium (e.g., computer-readable storage device 118 of FIG. 1) and the first data and second data corresponds to the enterprise services. Structured service descriptions are automatically generated based on the first data and the second data (306). Each of the service descriptions is associated with one of the enterprise services and corresponds to the unified schema. The structured service descriptions are stored in a service repository (e.g., RDF repository 204 of FIG. 2) (308). The service repository is provided in a computer-readable storage medium (e.g., computer-readable storage device 118 of FIG. 1).

Implementations of the present disclosure provide for the automated creation of rich and structured enterprise service descriptions from existing sources, which enable automated and high quality service discovery and composition. Implementations of the present disclosure are applicable to any industrial service oriented architecture (SOA) system, and exploit the syntactic structure of an associated governance model, and not the semantics (i.e., the specific meaning of the governance methodology). As discussed herein, low level technical data is combined with business meta-data about the extracted enterprise service, enabling a developer familiar with technical aspects, and having incomplete knowledge regarding business terminology, to identify relevant enterprise services based on the technical knowledge. In this manner, the involvement of a business expert can be reduced in the implementation of custom business systems.

As discussed herein, implementations of the present disclosure can be used by both humans and programs. The usage of the standard SPARQL query language, for example, enables both types of users to interact with the resulting service repository. With regard to human users, implementations of the present disclosure provide improved search capabilities for enterprise services using both technical and business terminology, as well as automatic categorization and labeling of enterprise services based on existing business terminology. By way of non-limiting example, all enterprise services that belong to a specific system version or application component can be filtered or labeled using one SPARQL query. With regard to programmatic users, the development of advanced service engineering techniques for existing SOA systems is enabled. In particular, implementations of the present disclosure enable automatic service composition and expose the available services for mashup engines. By way of non-limiting example, all data types of particular enterprise services can be modeled using a unified data model (e.g., GDT). Using SPARQL, enterprise services with similar parameters can be matched and compositions of enterprise services can be found for a desired business use case.

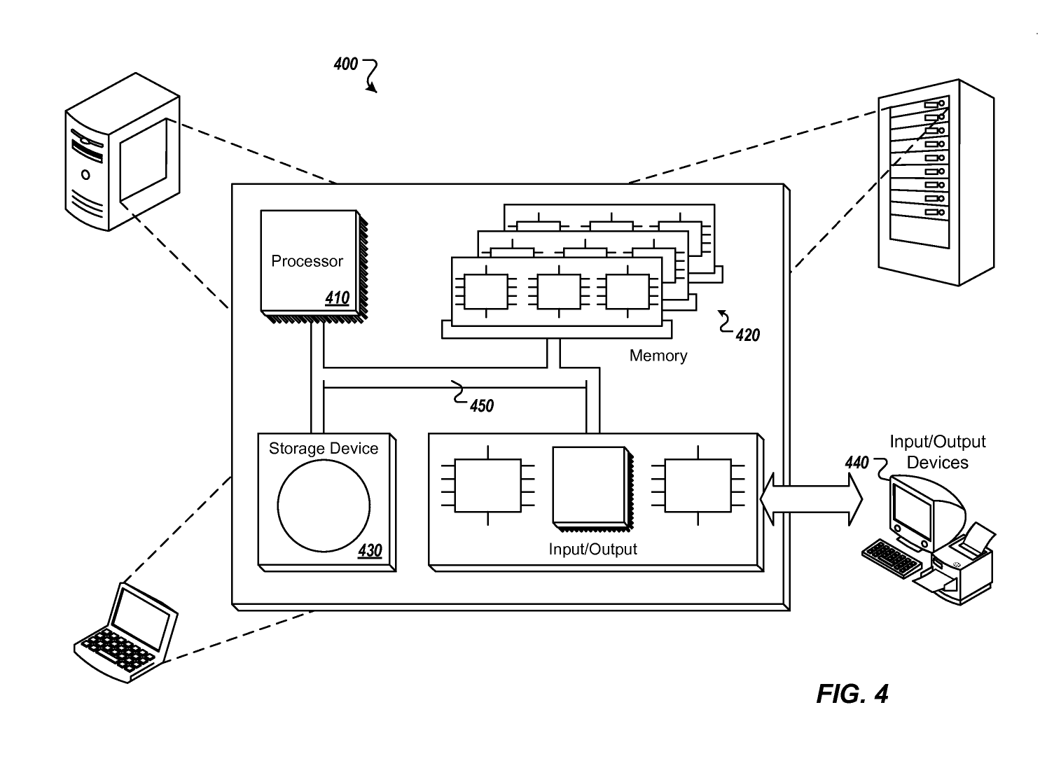

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit. The storage device 430 is capable of providing mass storage for the system 400. In one implementation, the storage device 430 is a computer-readable medium. In various different implementations, the storage device 430 may be a floppy disk device, a hard disk device, an optical disk device, or a tape device. The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for generating structured service descriptions corresponding to one or more enterprise services, the method comprising:
defining a unified schema based on a governance process that is used to develop enterprise services stored within a business service repository;
executing, using one or more processors, a first data importer and a second data importer;
retrieving first data and second data from the business service repository using the first data importer and the second data importer, respectively, the business service repository being provided in a computer-readable storage medium and the first data and the second data corresponding to the enterprise services;
automatically generating, using the one or more processors, structured service descriptions based on the first data and the second data, each of the structured service descriptions corresponding to the unified schema and being associated with one of the enterprise services; and
storing the structured service descriptions in a service repository, the service repository being provided in a computer-readable storage medium.

2. The method of claim 1, wherein the first data importer comprises a resource description framework (RDF) importer, the unified schema comprising an RDF schema, and the first data comprises structured programmatic access information for accessing the enterprise services.

3. The method of claim 2, wherein generating structured service descriptions comprises transforming the first data to one or more RDF tuples.

4. The method of claim 3, wherein each of the one or more RDF tuples comprises an RDF triple having a subject, predicate and object.

5. The method of claim 1, wherein the second data importer comprises a meta-data importer and the second data comprises semi-structured information regarding the enterprise services.

6. The method of claim 5, wherein generating structured service descriptions comprises transforming the second data to one or more corresponding RDF tuples.

7. The method of claim 6, wherein each of the one or more RDF tuples comprises an RDF triple having a subject, predicate and object.

8. The method of claim 1, wherein the first data comprises technical interface data corresponding to the enterprise services and is provided in a format for describing enterprise services.

9. The method of claim 8, wherein the format corresponds to Web Service Description Language (WSDL).

10. The method of claim 1, wherein the second data comprises one or more of business context data, business process data and system version data, and the second data is provided in a semi-structured format.

11. The method of claim 10, wherein the format corresponds to Hyper-text Mark-up Language (HTML).

12. The method of claim 1, further comprising:
executing, using one or more processors, a third data importer; and
retrieving third data from a data repository using the third data importer, the data repository being provided in a computer-readable storage medium and the third data corresponding to the enterprise services, wherein the structured service descriptions are generated further based on the third data.

13. The method of claim 12, wherein the third data corresponds to one or more application program interfaces (APIs) associated with the enterprise services.

14. The method of claim 1, further comprising:
receiving user input;
querying the service repository based on the user input;
generating results based on querying; and
outputting the results to a user.

15. The method of claim 14, wherein the user input is provided in SPARQL Protocol and RDF Query Language (SPARQL).

16. The method of claim 14, wherein the user input is generated by one of a human user and a programmatic user.

17. The method of claim 1, further comprising:
receiving user input; and
configuring the second data importer to recognize a set of elements of the second data and to map the second data to a schema associated with the service repository.

18. The method of claim 17, wherein the set of elements comprises HTML elements that hold the second data, the second data importer being configured to map the second data to RDF predicates.

19. A computer-readable storage medium coupled to one or more processors and having instructions stored thereon which, when executed by the one or more processors, cause the one or more processors to perform operations for generating structured service descriptions corresponding to one or more enterprise services, the operations comprising:
defining a unified schema based on a governance process that is used to develop enterprise services stored within a business service repository;
executing, using the one or more processors, a first data importer and a second data importer;
retrieving first data and second data from the business service repository using the first data importer and the second data importer, respectively, the business service repository being provided in a computer-readable storage medium and the first data and the second data corresponding to the enterprise services;
automatically generating, using the one or more processors, structured service descriptions based on the first data and the second data, each of the structured service descriptions corresponding to the unified schema and being associated with one of the enterprise services; and
storing the structured service descriptions in a service repository, the service repository being provided in a computer-readable storage medium.

20. A system, comprising:
a computing device; and
a computer-readable storage device coupled to the computing device and having instructions stored thereon which, when executed by the computing device, cause the computing device to perform operations for generating structured service descriptions corresponding to one or more enterprise services, the operations comprising:
defining a unified schema based on a governance process that is used to develop enterprise services stored within a business service repository;
executing, using the computing device, a first data importer and a second data importer;
retrieving first data and second data from the business service repository using the first data importer and the second data importer, respectively, the business service repository being provided in a computer-readable storage medium and the first data and the second data corresponding to the enterprise services;
automatically generating, using the one or more processors, structured service descriptions based on the first data and the second data, each of the structured service descriptions corresponding to the unified schema and being associated with one of the enterprise services; and
storing the structured service descriptions in a service repository, the service repository being provided in a computer-readable storage medium.
